(19) United States
(12) Patent Application Publication
(10) Pub. No.: US 2002/0080819 A1
(43) Pub. Date: Jun. 27, 2002

(54) Packet tunneling method in mobile data communication network

(76) Inventor: Shiao-Li Tsao, Taipei (TW)

Correspondence Address: BACON & THOMAS PLLC, 625 Slaters Lane-4th Floor, Alexandria, VA, 22314-1176, US

(21) Appl. No.: 09/761,704

(22) Filed: Jan. 18, 2001

(30) Foreign Application Priority Data
Oct. 30, 2000 (TW) 89122779

(51) Int. Cl. H04J 3/16

(52) U.S. Cl. 370/469; 370/491

(57) ABSTRACT

There is disclosed a packet tunneling method in a mobile data communication network. The packet tunneling method first uses a tunneling protocol to set up tunneling information and uniquely identify a tunnel in a signaling procedure. Then, in a data transmission procedure, the information provided by an addressing mechanism of a packet itself is used to tunnel the packet from one routing node to another with the tunneling information and the uniquely identified tunnel, so as not to use a tunneling protocol in the packet.

### BACKGROUND OF THE INVENTION

1. Field of the Invention

The present invention relates to the field of mobile communication and, more particularly, to a packet tunneling method in a mobile data communication network.

2. Description of Related Art

Recent advances in wireless technologies makes it possible to provide packet data services on mobile communication networks. Besides the traditional circuit-switch voice service, personal communication system is tended to provide packet switch and Internet access services. General packet radio service (GPRS) is one of the example to extend data service over personal communication system.

According to the specifications defined in GPRS, mobile stations (MSs) in a public land mobile network (PLMN) can have packet transmitting/receiving capabilities to terminal equipment (TE) connected to a packet data network (PDN) or MSs in another PLMN.

FIG. 11 shows the overall architectures and interfaces between nodes of a GPRS network. Packets from TE 902 on a PDN 901 will be routed to Gateway GPRS support node (GGSN) 903 and further transferred to a mobile station (MS) 904 in a PLMN, and packets from MS 904 will be sent to its GGSN via the base station system (BSS) 906 and then routed to a certain TE. To bring up a packet switch call, GPRS defines a number of activation procedures. After accomplishing a set of signaling procedures, MS 904 or TE 902 can have packet communications to each other.

GPRS provides two service modes to MS, i.e. transparent mode and non-transparent mode. In transparent mode, an MS 904 is given an address belonging to the operator's addressing space. The address can be either statically assigned or be allocated dynamically, but the address should be transparent to hosts out of the PLMN. The unique address will be used for packets routing in a data network. Another operational mode is non-transparent mode. In non-transparent mode, an MS 904 is given a private address belonging to an Intranet or Internet service provider (ISP). The address can be also given either at subscription in which case it is a static address or at connection request as a dynamic address. However, the address is non-transparent to the hosts connecting to the PLMN. Packets to the MS 904 should be first routed to the GGSN 903, replaced its destination address by the private address of the MS 904 at the PLMN, tunneled to Serving GPRS Support Node (SGSN) 905 and then forwarded to the MS 904. In that way, data will have a better protection and the addresses can be reused.

Since the address may reuse in different operators, two MSs with the same static address may register in the same cell and are served by the same SGSN and GGSN. Moreover, a mobile host may roam between SGSNs and may request the in-sequence delivery service, thus a tunneling protocol is needed in a PLMN. GPRS defines a tunneling protocol, called GPRS tunneling protocol (GTP) in their specifications. It defines protocol between GSNs in the GPRS backbone network. It includes both the GTP signaling and data transfer procedures. GTP allows multi-protocol packets to be tunneled through GPRS backbone. In the signaling plane, GTP specifies a tunnel control and management protocol which allows the SGSN to provide GPRS network access for an MS. In the transmission plane, GTP uses a tunneling mechanism to provide services for carrying user data packets.

However, the use of GTP protocol requires additional GTP header and thus extra processing has to be done. Thus, the transmission performance of the mobile data communication network will be negatively affected. Accordingly, it is desirable to provide an improved packet tunneling method that is able to provide the GTP function without degrading the transmission performance.

### SUMMARY OF THE INVENTION

The object of the present invention is to provide a packet tunneling method in a mobile data communication network for avoiding a performance degradation caused by using the tunneling protocol.

To achieve the object, the packet tunneling method first uses a tunneling protocol to set up tunneling information and uniquely identify a tunnel in a signaling procedure. Then, in a data transmission procedure, the method uses information provided by an addressing mechanism of a packet itself to tunnel the packet from one routing node to another with the tunneling information and the uniquely identified tunnel supported in step (A), so as not to use a tunneling protocol in the packet.

Other objects, advantages, and novel features of the invention will become more apparent from the following detailed description when taken in conjunction with the accompanying drawings.

### BRIEF DESCRIPTION OF THE DRAWINGS

FIG. 1 shows a signaling procedure for activating PDP context;

FIG. 2 shows a PDP context deactivation procedure initiated by MS;

FIG. 3 shows a PDP context deactivation procedure initiated by SGSN;

FIG. 4 shows a PDP context deactivation procedure initiated by GGSN;

FIG. 5 shows an example of packet routing from TE to MS without involving tunneling PDP address;

FIG. 6 shows an example of packet routing from MS to TE without involving tunneling PDP address;

FIG. 7 shows an inter SGSN packet forwarding without involving tunneling PDP address;

FIG. 8 shows part of a roaming procedure for inter SGSN routing area update;

FIG. 9 shows an example of packet routing from TE to MS involving tunneling PDP address;

FIG. 10 shows an inter SGSN packet forwarding involving tunneling PDP address; and

FIG. 11 schematically illustrates the overall architecture and interfaces between nodes of a GPRS network.

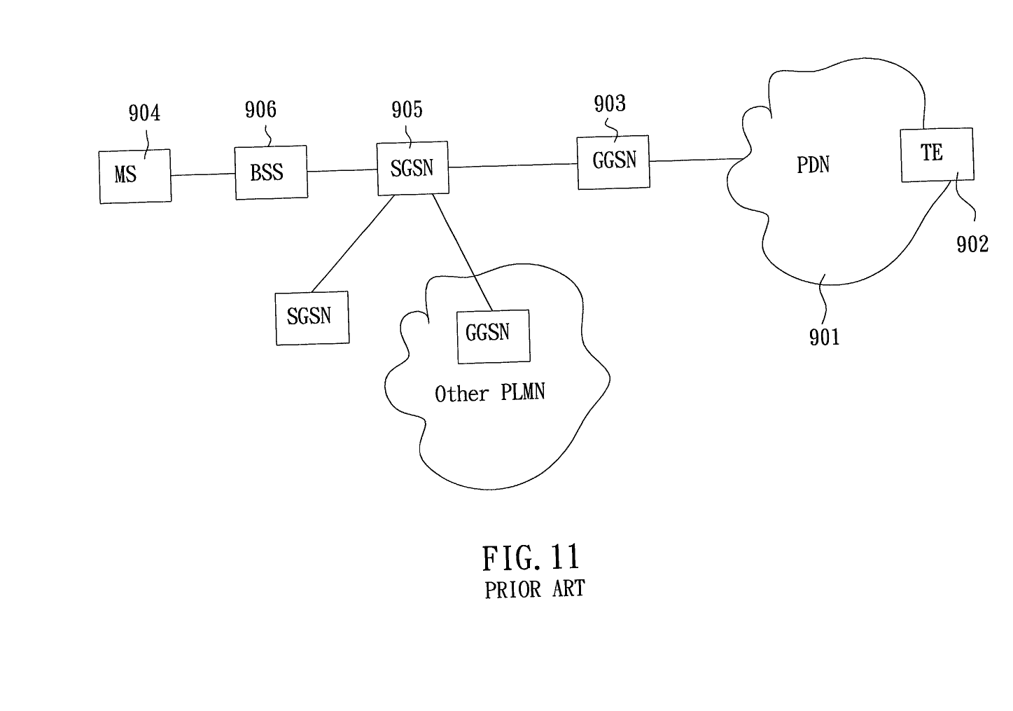

### DETAILED DESCRIPTION OF THE PREFERRED EMBODIMENT

The present invention provides a packet tunneling method in a mobile data communication network. In general, a tunneling protocol consists of two phases. The first phase, i.e. signaling procedure, is used to set up tunneling information, and associates packet data protocol (PDP) and mobility management (MM) context on routing nodes of a mobile data network with a unique tunnel identifier. The second phase, i.e. data transmission procedure, is used to tunnel packets from one routing node to another by encapsulating the original packets into the tunneling protocol. However, these packets from mobile stations or from hosts outside the mobile data network have their own addressing mechanisms. The packet tunneling method in accordance with the present invention utilizes the information to accomplish the functionality of tunneling protocols, thereby removing the tunneling protocol during transmission phase.

To depict the method of the present invention, a GPRS system and Internet Protocol (IP) based network addressing and routing mechanisms are illustrated for illustrative purpose only.

Because the method of the present invention does not use tunneling protocol in the data transmission procedure, the packet to be transmitted will not have a GTP header, which generally contains the information as listed in the following Table 1.

TABLE 1

| | | | |
|---|---|---|---|
| Version | PT | Spare ‘111’ | SNN |

Message Type
Length
Sequence Number
Flow Label
SNDCP N-PDU Number
Spare ‘11111111’
Spare ‘11111111’
Spare ‘11111111’
Tunnel Identifier (8 Bytes)
. . . . .
As shown, the GTP header has some important information contained in the fields as follows:
(1) Length: indicating the size of the packet;
(2) Sequence Number: used for packet duplication detection, insequence delivery and dropping;
(3) SNDCP N-PDU Number: used for GSNs packet forwarding;
(4) Flow Label: indicating the flow in a tunnel; and
(5) Tunnel identifier: identifying the unique mobility management (MM) and packet data protocol (PDP)
# information for a mobile station.

Considering the case that packets from packet data network (PDN) has it own network protocols such as IP and X.25, most of the above functions can be carried out by the protocols, such that the major function of the GTP header can be maintained even though the GTP header is removed. Herein, IP is used as an example. Table 2 depicts the IP header as follows.

TABLE 2

| | |
|---|---|
| Version | Header length |
| Type of Service | |
| Length (2 Bytes) | |
| Identification (2 Bytes) | |
| 3-bit flag | 13-bit fragment offset |
| 3-bit flag | 13-bit fragment offset |

Time to live
Time to live
Protocol
Header checksum (2 Bytes)
32-bit source IP address
32-bit destination IP address

The 16-bit length in IP header can replace the length information in GTP. The 16-bit identification is used to replace the 8-bit sequence number in GTP. Therefore, the length and sequence number information can be carried by the original network protocol.

In the signaling procedure, the method of the present invention creates two extra data items in PDP contexts. The extra information shall be maintained in the GPRS support nodes (GSNs). Combining with the extra information and some original PDP context information can uniquely identify a tunnel. The important routing PDP information stored on the SGSN and GGSN are listed in the following Table 3 and Table 4 respectively.

TABLE 3

| Field | Description |
|---|---|
| PDP Context Identifier | Index of the PDP context. |
| PDP State | Packet data protocol state, INACTIVE or |
| | ACTIVE. |
| PDP Type | PDP type, e.g., X.25, PPP or IP. |
| Tunneling PDP Address | Specifies whether the Tunneling PDP address is |
| Flag | used or not. |
| PDP Address | PDP address, e.g., an X. 121 address. |
| Tunneling PDP Address | Tunneling PDP address, e.g., an X.121 address. |
| NSAPI | Network layer service address point identifier. |
| GGSN Address in Use | The IP address of the GGSN currently used. |
| Send N-PDU Number | SNDCP sequence number of the next downlink |
| | N-PDU to be sent to the MS. |
| Receive N-PDU Number | SNDCP sequence number of the next uplink N- |
| | PDU expected from the MS. |
| SND | GTP sequence number of the next downlink N- |
| | PDU to be sent to the MS. |
| SNU | GTP sequence number of the next uplink N- |
| | PDU to be sent to the GGSN. |

TABLE 4

| Field | Description |
|---|---|
| IMSI | International Mobile Subscriber Identity |
| NSAPI | Network layer service address point identifier. |
| PDP Type | PDP type, e.g., X.25, PPP or IP. |
| Tunneling PDP Address | Specifies whether the Tunneling PDP address is |
| Flag | used or not. |
| PDP Address | PDP address, e.g., an X. 121 address. |
| Tunneling PDP Address | Tunneling PDP address, e.g., an X.121 address. |
| Dynamic Address | Indicates whether PDP address is static or |
| | dynamic |
| SGSN Address | The IP address of the SGSN currently serving |
| | this MS. |
| SND | GTP sequence number of the next downlink N- |
| | PDU to be sent to the MS. |
| SNU | GTP sequence number of the next uplink N- |
| | PDU to be sent to the GGSN. |

In Table 3, a “Tunneling PDP Address Flag” field and a “Tunneling PDP Address” field are created, such that one of the PDP address and tunneling PDP address is selected based on the value of the tunneling PDP address flag. Similarly, in Table 4, a “Tunneling PDP Address Flag” field and a “Tunneling PDP Address” field are created, and one of the PDP address and tunneling PDP address is selected based on the value of the tunneling PDP address flag.

After creating the two extra data items in PDP contexts, all signaling procedures defined in GTP are remained, and the subsequent procedures can be accomplished successfully, wherein the signaling procedures are used to set up the mobility management (MM) and packet data protocol (PDP) context on GSNs for packet routing and tunneling. The method of the present invention uses PDP addresses as the unique key to locate MM and PDP context on GSNs instead of tunnel identifier in GTP. If the PDP address is assigned dynamically, GGSN should make sure that the address is unused and can identify a single MM and PDP context of a mobile station. If the PDP address is assigned to a mobile station statically, new connection setup procedures are required.

Assuming that an MS with a static address initiates a packet service, it first requests SGSN with its PDP information. Then, SGSN forwards the requests to GGSN with the PDP information. For GPRS non-transparent mode, PDP addresses can be reused by operators, the requested PDP address may be currently in use by other mobile stations belonging to other operators or ISPs in the same GGSN coverage. In the present invention, once a GGSN gets the request with a static PDP address, it searches in its database. If the address has been used, GGSN will response a new and unused private PDP address to SGSN. The SGSN and GGSN will use this private address as tunneling identifier. That is, the GGSN and SGSN will set the tunneling PDP address flags to 1 for indicating that the data packets will be tunneled by using tunneling address, instead of PDP address, in the packets.

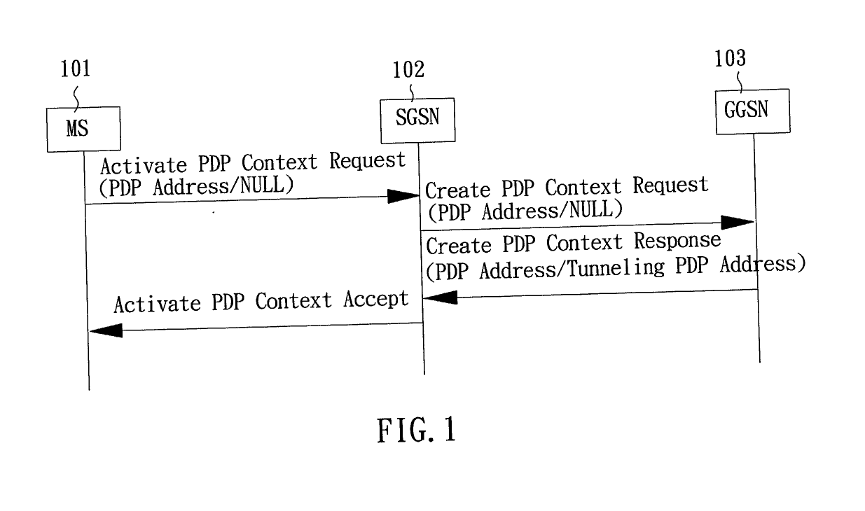

FIG. 1 shows the PDP context activation procedure. Mobile station 101 first initiates an activate PDP context request with a null or a static PDP address, wherein the null PDP address indicates that a dynamic PDP address is requested. Once SGSN 102 gets the activate PDP context request from the mobile station 101, it forwards the request to GGSN 103. If addresses are dynamically assigned, GGSN 103 will response an unused PDP address to SGSN 102 and MS 101. The PDP address will be used as the tunnel identifier. If a static PDP address is requested, GGSN 103 should consider a situation that the PDP address has been used by other MS. In case that the PDP address has not been used, GGSN 103 will response the PDP address to SGSN 102 and MS 101 for being used as the tunnel identifier. In case that the PDP address has been used, the requested PDP address is still maintained in the SGSN 102 and GGSN 103, but a unique tunneling address is allocated as tunnel identifier between GGSN 102 and SGSN 103.

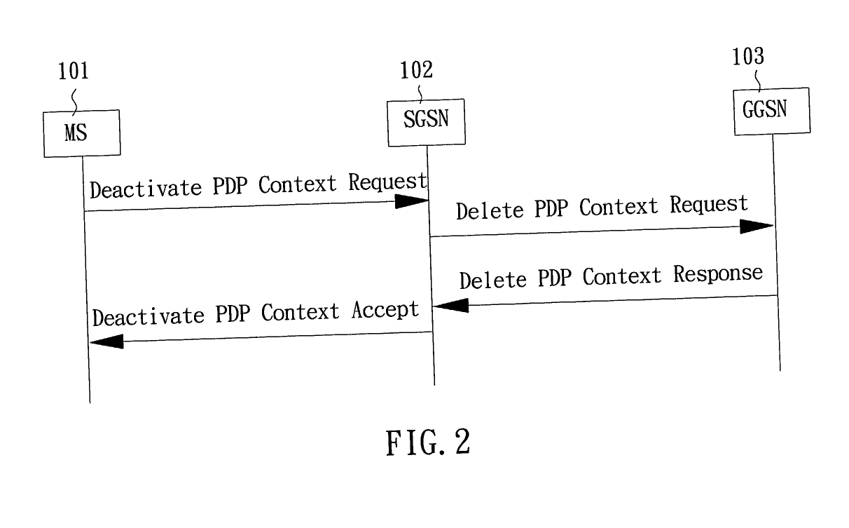

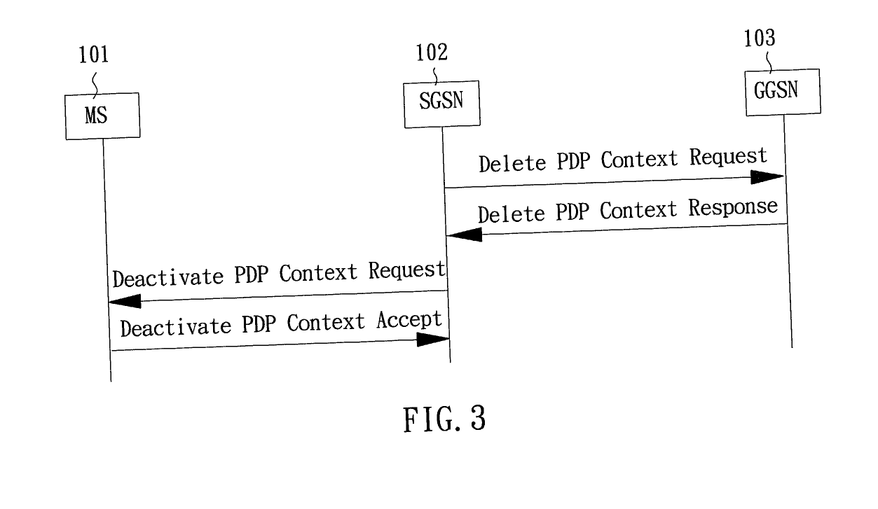

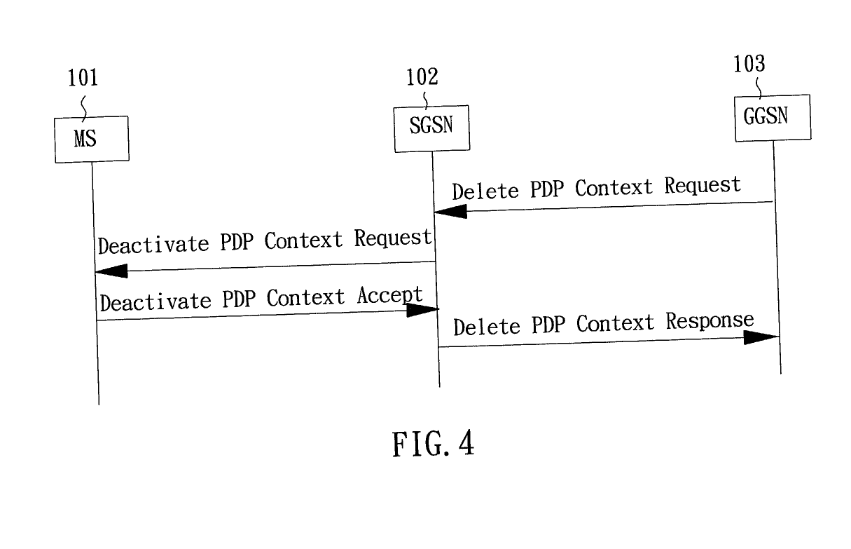

The established connection as described above can be closed at the end of communication. FIGS. 2, 3 and 4 depict three different situations of closing connections initiated by MS 101, SGSN 102, and GGSN103, respectively, so as to release the tunneling address.

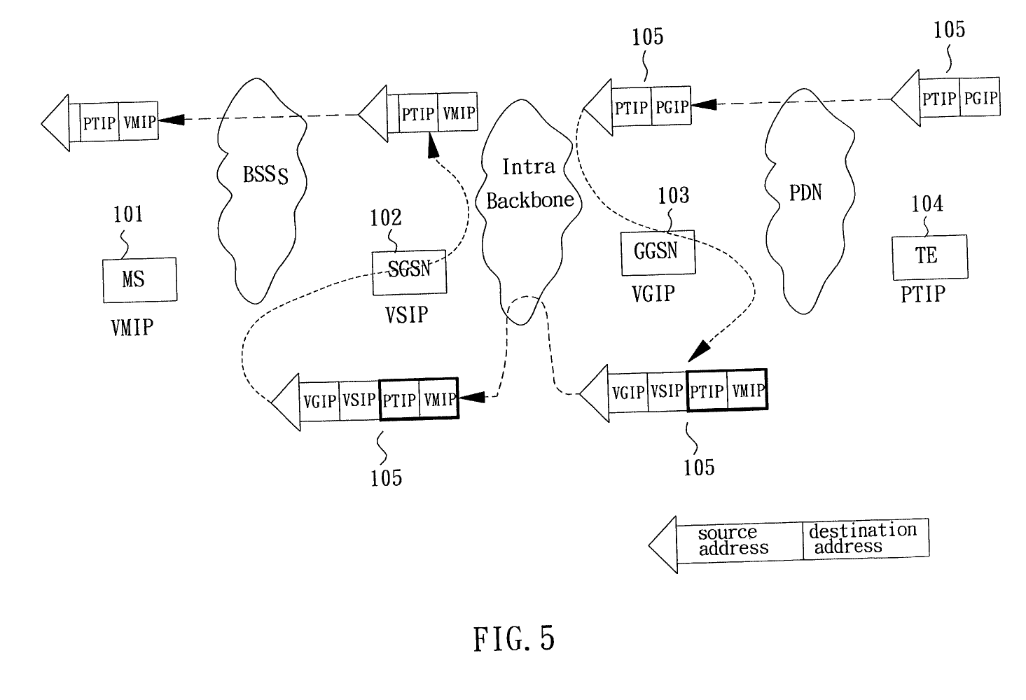

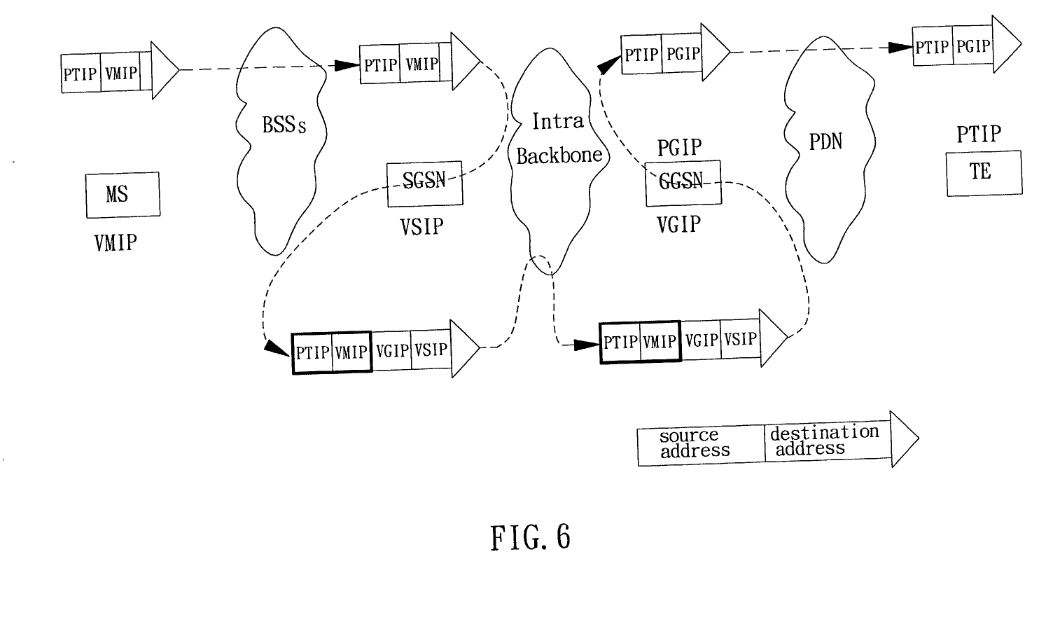

Once a unique PDP address or tunneling PDP address is assigned for packet tunneling, the data transmission procedure, i.e. the packet routing and tunneling, within a PLMN can be realized without GTP. FIG. 5 shows an example of packets routing from terminal equipment (TE) 104 outside the PLMN to an MS 101. In non-transparent mode, the GGSN address is published to outside hosts, and such a public GGSN address is denoted by PGIP. Data communication to MSs can perform address translation on GGSN. GGSN can apply network address translator (NAT) technique or etc. to solve the address translation problem. Packets 105 from TE 104 are routed to the GGSN 103 where the MS 101 locates. Then, the packets 105 are processed by GGSN 103. The destination of the original packet 105 (i.e., the public GGSN address PGIP) will be replaced by the private PDP address of the MS 101 (denoted by VMIP). After that, GGSN 103 encapsulates the received packets 105 in IP protocol where the source address is the private address of the GGSN 103 (denoted by VGIP) and the destination is the private address of the SGSN 102 (denoted by VSIP). The routing information can be resolved by PDP and MM contexts on GSNs. After SGSN 102 picks up the packets 105, it realizes the packet 105 carries another IP packet from its header. For example, the packet 105 can be identified in the protocol type field of an IP header. SGSN 102 opens the packets, decodes the destination PDP address, and searches PDP context on SGSN database based on its PDP address. Then, SGSN 102 can resolve the routing for the packets. FIG. 6 shows the reversed direction where packets are sent from MSs to outside TEs.

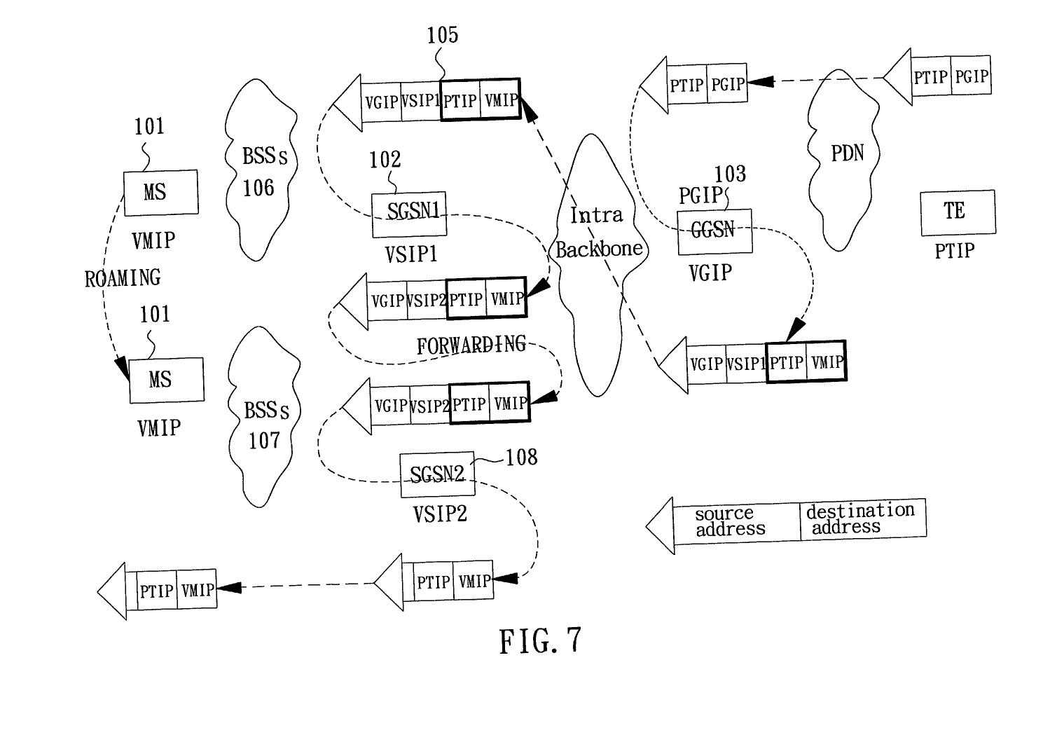

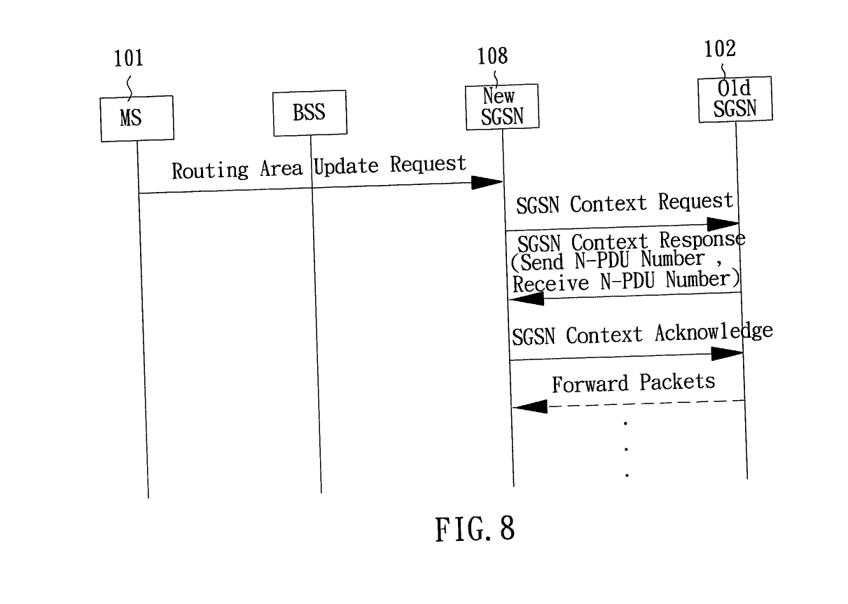

Because the mobile station may be freely moved in the PLMN, the packet transmission must consider the roaming of the mobile station. With reference to FIG. 7, there is shown a situation of inter SGSN packet forwarding without involving tunneling PDP address, wherein an MS 101 is roaming from a base station system (BSS) 106 to another one 107 in the same GGSN. Before the MS 101 completely roams to the new SGSN 108, some packets may route to old SGSN 102. These packets must be forwarded to the new SGSN 108 by the old SGSN 102. The private PDP address of the mobile station (VMIP) still can be used as the unique identifier. The old SGSN 102 replaces the destination address of the routing protocol (i.e., the private address of the original SGSN 102, denoted by VSIP1) with the new SGSN private address (denoted by VSIP2) and forwards the packets 105 to the new SGSN 108. However, the SNDCP protocol employed in BSS networks needs a sequential number to control the packet delivery, the new SGSN 108 can not resolve this number if the sequence number and SNDCP number are eliminated in GTP header. To inform the new SGSN 108 the start number in SNDCP packets of consecutive packets, two new parameters are inserted for roaming signaling procedures. With reference to FIG. 8, there is shown part of the inter SGSN routing area update procedure. As shown, when the MS 101 sends a routing area update request to the new SGSN 108 due to roaming, the new SGSN 108 issues a SGSN context request, and the old SGSN 102 responses a SGSN context response with its sending N-PDU number and receiving N-PDU number. In that way, the new SGSN 108 can use these two parameters to initial SNDCP protocol stack in the new SGSN 108, so as to control the packet transmission.

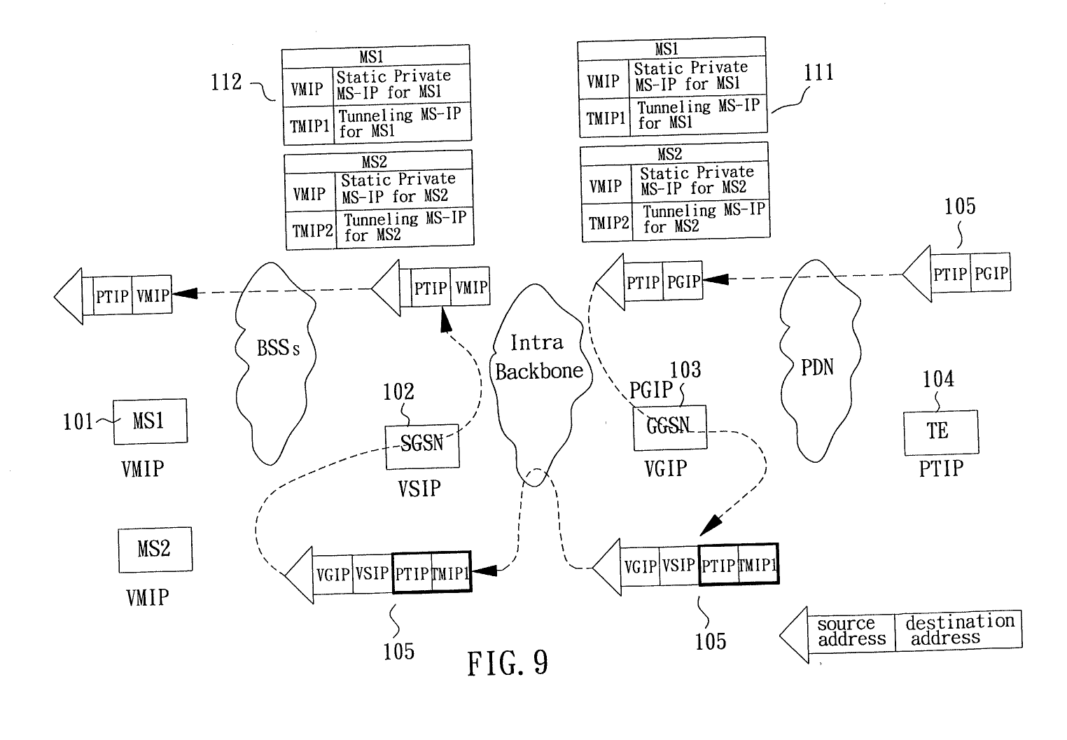

If an MS has a static PDP address and the PDP address has been used in the PLMN, a tunneling PDP address shall be allocated. The tunneling PDP address is only for tunneling between GSNs. The mapping between tunneling addresses and MSs address should be transparent to MSs. With reference to FIG. 9, there is shown a situation of packet routing from TE 104 to MS 101 involving tunneling PDP address. Packets 105 routing from TE 104 to GGSN 103 remain unchanged. GGSN 103 gets the PDP information and finds that the tunnel address is enabled. After checking a PDP context table 111, GGSN 103 replaces the destination PDP address (the public GGSN address, PGIP) by the tunneling PDP address (MS's tunneling PDP address, TMIP1) and transmits the packets 105 to SGSN 102. SGSN 102 gets the packet 105, and finds the PDP information by the tunneling PDP address (MS's tunneling PDP address, TMIP1). After checking a PDP context table 112, SGSN 102 replaces tunneling address (MS's tunneling PDP address, TMIP1) by MS's real PDP address (VMIP), and forwards the packets 105 to the MS 101.

As to the packet transmission when the mobile station is roaming, with reference to FIG. 7, there is shown a situation of inter SGSN packet forwarding involving tunneling PDP address, wherein an MS 101 is roaming form a base station system (BSS) 106 to another one 107 in the same GGSN.

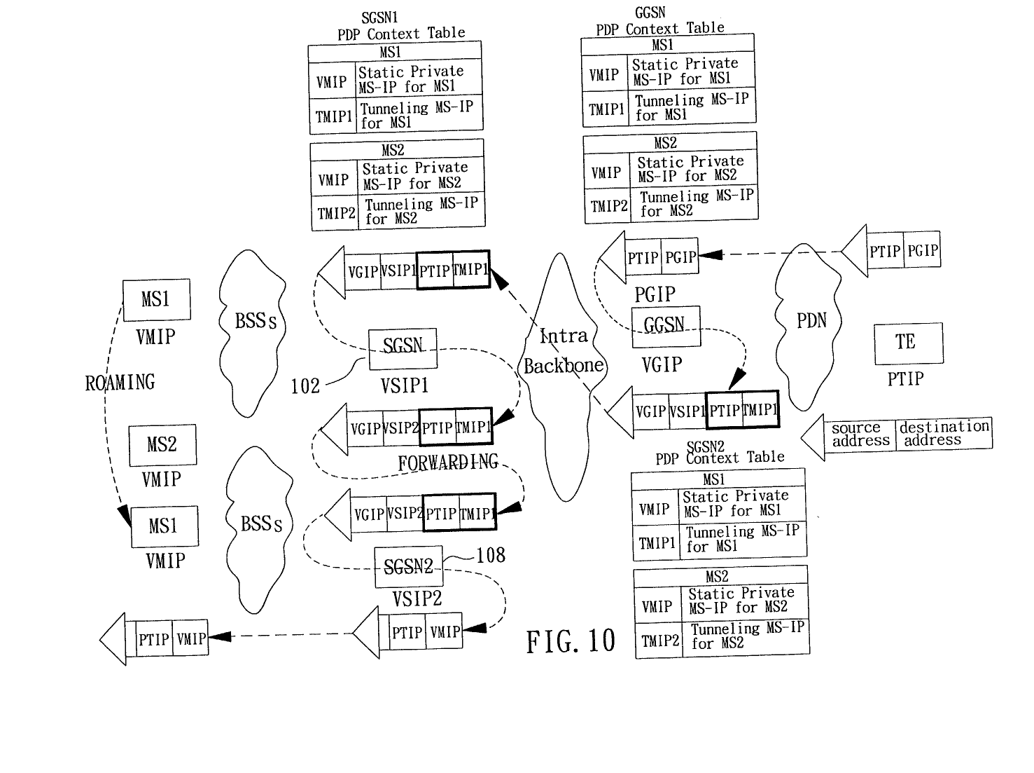

FIG. 10 shows the situation while the tunnel address is used during inter SGSN roaming, wherein packets are forwarded from SGSN 102 to another SGSN 108. The procedures are similar to the one in FIG. 7. The only difference is that the replacement of the tunnel address (MS's tunneling PDP address, TMIP1) to real MS's PDP address (VMIP) is performed by the new SGSN 108.

In addition, although the flow identifier, used to distinguish flows aggregate in the same tunnel, in the GTP header has been eliminated, the signaling flow can still have its unique flow identifier since the invention does not remove the signaling formats and signaling procedures. As for the transmission of data packets, the flows in the same channel can be separated by PDP information in GSNs, so as not to cause any problems in flow control.

Although the present invention has been explained in relation to its preferred embodiment, it is to be understood that many other possible modifications and variations can be made without departing from the spirit and scope of the invention as hereinafter claimed.

What is claimed is:

1. A packet tunneling method in a mobile data communication network, comprising the steps of:
(A) using a tunneling protocol to set up tunneling information and uniquely identify a tunnel in a signaling procedure; and
(B) using information provided by an addressing mechanism of a packet itself to tunnel the packet from one routing node to another with the tunneling information and the uniquely identified tunnel provided by step (A) in a data transmission procedure, so as not to use a tunneling protocol in the packet.

2. The packet tunneling method in a mobile data communication network as claimed in claim 1, wherein, in step (B), the addressing mechanism of the packet has a length and identification for being used to replace the length and sequence number required by the tunneling protocol.

3. The packet tunneling method in a mobile data communication network as claimed in claim 1, wherein, in step (A), packet data protocol (PDP) context and mobility management (MM) context on routing nodes of the mobile data network are associated with a unique tunnel identifier to uniquely identify a tunnel.

4. The packet tunneling method in a mobile data communication network as claimed in claim 3, wherein the PDP context has a tunneling PDP address flag, a tunneling PDP address and a PDP address, and one of the tunneling PDP address and PDP address is selected based on the tunneling PDP address flag.

5. The packet tunneling method in a mobile data communication network as claimed in claim 4, wherein the tunnel is uniquely identified by a PDP context activation procedure.

6. The packet tunneling method in a mobile data communication network as claimed in claim 5, wherein, if the PDP context activation procedure requests an dynamic PDP address, the network responses an unused PDP address for being used as a tunnel identifier.

7. The packet tunneling method in a mobile data communication network as claimed in claim 5, wherein, if the PDP context activation procedure requests a static PDP address and the PDP address has been used, the network assigns a tunneling PDP address as a tunnel identifier.

8. The packet tunneling method in a mobile data communication network as claimed in claim 1, which is relied on a general packet radio service (GPRS) system and Internet protocol (IP) based network addressing and routing mechanisms for providing packet transmission service.

9. The packet tunneling method in a mobile data communication network as claimed in claim 8, wherein, in step (B), the addressing mechanism of the packet has a length and identification in an IP header for being used to replace the length and sequence number required by a GPRS tunneling protocol (GTP) of the GPRS system.

10. The packet tunneling method in a mobile data communication network as claimed in claim 8, wherein, in step (A), packet data protocol (PDP) context and mobility management (MM) context on routing nodes of the mobile data network are associated with a unique tunnel identifier to uniquely identify a tunnel.

11. The packet tunneling method in a mobile data communication network as claimed in claim 10, wherein the PDP context has a tunneling PDP address flag, a tunneling PDP address and a PDP address, and one of the tunneling PDP address and PDP address is selected based on the tunneling PDP address flag.

12. The packet tunneling method in a mobile data communication network as claimed in claim 11, wherein the tunnel is uniquely identified by a PDP context activation procedure.

13. The packet tunneling method in a mobile data communication network as claimed in claim 12, wherein, if the PDP context activation procedure requests an dynamic PDP address, the network responses an unused PDP address for being used as a tunnel identifier.

14. The packet tunneling method in a mobile data communication network as claimed in claim 12, wherein, if the PDP context activation procedure requests a static PDP address and the PDP address has been used, the network assigns a tunneling PDP address as a tunnel identifier.

15. The packet tunneling method in a mobile data communication network as claimed in claim 12, wherein the network has at least a gateway GPRS support node (GGSN) and serving GPRS support node (SGSN) for transmitting packets between a terminal equipment and a mobile station.

16. The packet tunneling method in a mobile data communication network as claimed in claim 15, wherein, when the PDP address is used as a tunnel identifier and the terminal equipment intends to route packets to the mobile station, the packet from the terminal equipment is first routed to the GGSN where the mobile station locates; then, the packet is processed by the GGSN for replacing the destination address of the packet with a private PDP address of the mobile station; next, the GGSN encapsulates the received packet in IP protocol where the source address is the private address of the GGSN and the destination address is the private address of the SGSN; after the SGSN picks up the packet, the SGSN opens the packet, decodes the destination PDP address, and searches PDP context on a SGSN database based on the PDP address, so as to achieve packet transmission.

17. The packet tunneling method in a mobile data communication network as claimed in claim 15, wherein, when the tunneling PDP address is used as a tunnel identifier and the terminal equipment intends to route packets to the mobile station, the packet from the terminal equipment is first routed to the GGSN; then, the GGSN gets PDP information and replaces the destination PDP address by the tunneling PDP address after checking a PDP context table, and the packet is transmitted to the SGSN; next, the SGSN gets the packet and finds the PDP information by the tunneling PDP address; after checking a PDP context table, the SGSN replaces tunneling address by mobile station's real PDP address, and forwards the packet to the mobile station.

18. The packet tunneling method in a mobile data communication network as claimed in claim 15, wherein, when a mobile station is roaming form a base station system to another one in the same GGSN, packet transmission is controlled by using a sending N-PDU number and receiving N-PDU number.
